(19) United States
(12) Patent Application Publication
(10) Pub. No.: US 2005/0091946 A1
(43) Pub. Date: May 5, 2005

(54) Dust collector

(75) Inventor: Chieh Yuan Cheng, Taichung (TW)

Correspondence Address: TROXELL LAW OFFICE PLLC, SUITE 1404, 5205 LEESBURG PIKE, FALLS CHURCH, VA, 22041, US

(73) Assignee: San Ford Machinery Co., Ltd.

(21) Appl. No.: 10/697,113

(22) Filed: Oct. 31, 2003

(51) Int. Cl. B01D 46/00

(52) U.S. Cl. 55/356; 55/366; 55/484; 55/378

(57) ABSTRACT

A dust collector includes an exhaust box and a support frame. The exhaust box consists of two housings, two intermediate half hoops and two annular bases. The two housings respectively have a flange to match with each other and two half hoops firmly keeps the combined two housings firmly combined together so the exhaust box is easily assembled together and quite air-tight, effectively upgrading assembling efficiency, lowering the cost, and having good air-tightness, a smooth and aesthetic appearance and collapsibility for reducing the size after collapsed.

### BACKGROUND OF THE INVENTION

1. Field of the Invention

This invention relates to a dust collector, particularly to one having an exhaust box combined with a tightly locking method of non-welding so as to upgrade assembling efficiency, lowering producing work and material costs, and increasing a holistic aesthetic appearance of the dust collector.

2. Description of the Prior Arts

FIG. 1 shows one of the most used conventional dust collectors, which includes an exhaust box 10, a fan motor 20 fixed on the exhaust box 10, a sucking pipe base 30 with a sucking hole 31, and two dust bags 40 positioned at two sides. The fan motor 20 operates to produce vacuum in the exhaust box 10 for sucking dust through the sucking hole 31 via the exhaust box 10 and then into the two dust bags 40 to be collected. The exhaust box 10 consists of an upper and a lower housing 11 and 11′, an intermediate annular member 12 and an upper and a lower annular base 13 and 13′. The upper and the lower housing 11 and 11′ respectively have a circumferential wall 111 and a flat plate 112 surrounded by the circumferential wall 111 as shown in FIGS. 2 and 3. The flat plate 112 has a hole 1121 for combining the fan motor 20 and another hole 1121 in the center and two large holes 1122 bored at two sides for the two annular bases 13, 13′ to fit in and welded. The upper and the lower annular base 13 and 13′ are for attaching the dust bags 40 around them firmly. The intermediate annular member 12 directly surrounds the circumferential walls 111, 111′ of the upper and the lower housing 11 and 11′, and then welded firmly together the both 12, 11, 11′ along the contacting lines, forming a sealed exhausting space for advantageously sucking and collect dust. In addition, a supporter 14 is provided to fix the exhaust box 10 thereon, having a support flat table 141 and a vertical pipe 142 respectively fixed at four corners of the support flat table 141 and having its upper end fixed firmly with the circumferential wall 111 of the housing of the exhaust box 10 for securing the exhaust box 10 stably.

However, the conventional dust collector has the following flaws.

1. The exhaust box 10 consists of the upper and the lower housing 11 and 11′ welded with the intermediate annular member 12, and in order to secure air-tight and structural strength, the welded locations includes an upper and lower contacting lines of the intermediate annular member 12 with the upper and the lower housing 11 and 11′, extending very long to result in long work time and high cost, not beneficial for manufacture.

2. As mentioned above, the intermediate annular member 12 is welded with the upper and the lower housing 11 and 11′, forming a long line and the welding scabs extends over the whole contacting lines, worsening the holistic outer appearance of the dust collector.

3. The welding lines of the intermediate annular member with the upper and the lower housing are long, requiring sophisticated welding technique, so high percentage of bad welding spots may happen, potential disqualified quality of the exhaust box may give rise to inferior air-tight characteristics.

4. The vertical pipes 142 are riveted firmly on the support flat table 141, so they are hard to take apart once assembled. Therefore, the conventional dust collector cannot be collapsed to become a smaller size advantageous for putting away, transporting, etc. Moreover, the vertical pipes 142 are independent in its design, and its side strength is comparatively weak, susceptible to exterior outside force to incline, impossible to secure the exhaust box 10 stably. Above all, the fan motor 20 on the exhaust box 10 is quite heavy, prone to incline, and if worse, maybe get broken while handling the supporter 14.

### SUMMARY OF THE INVENTION

One purpose of the invention is to offer a dust collector provided with an upper and a lower housing directly banded tightly together by means of an tightening hoop, with the exhaust box combined together firmly and extremely air-tight, with assembling work being simple and quick, lowering the cost and ensuring its whole outer aesthetic appearance.

Another purpose of the invention is to offer a dust collector having a collapsible support frame respectively propping up two sides of the dust collector, and each collapsible support frame has two U-shaped upper frames with an upper horizontal portion to be screwed firmly with the side wall edge of the lower housing kept stably on the collapsible support frame, permitting the dust collector assembled and collapsed easily and quickly.

### BRIEF DESCRIPTION OF DRAWINGS

This invention will be better understood by referring to the accompanying drawings, wherein:

FIG. 1 is a perspective view of a conventional dust collector;

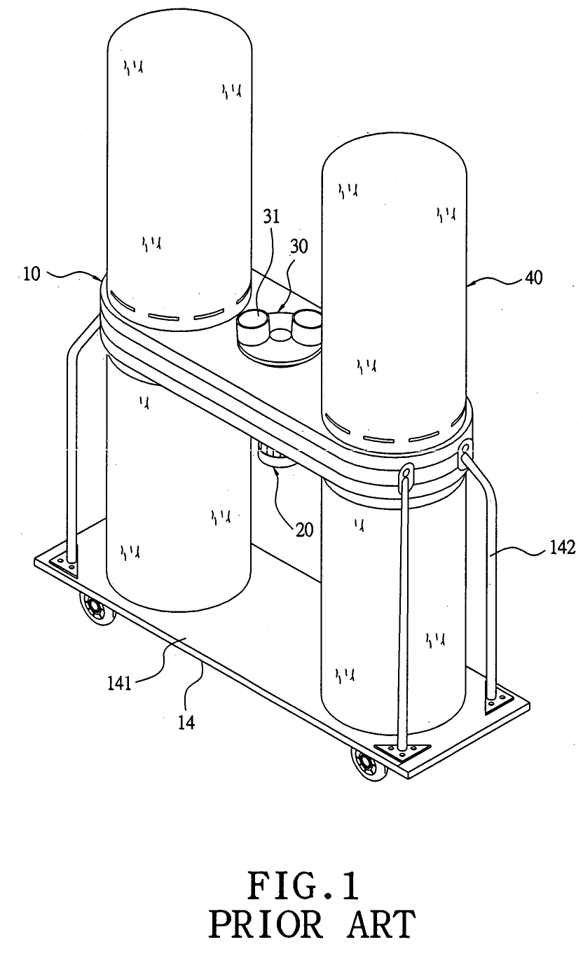

FIG. 2 is an exploded perspective view of an exhaust box in the conventional dust collector;

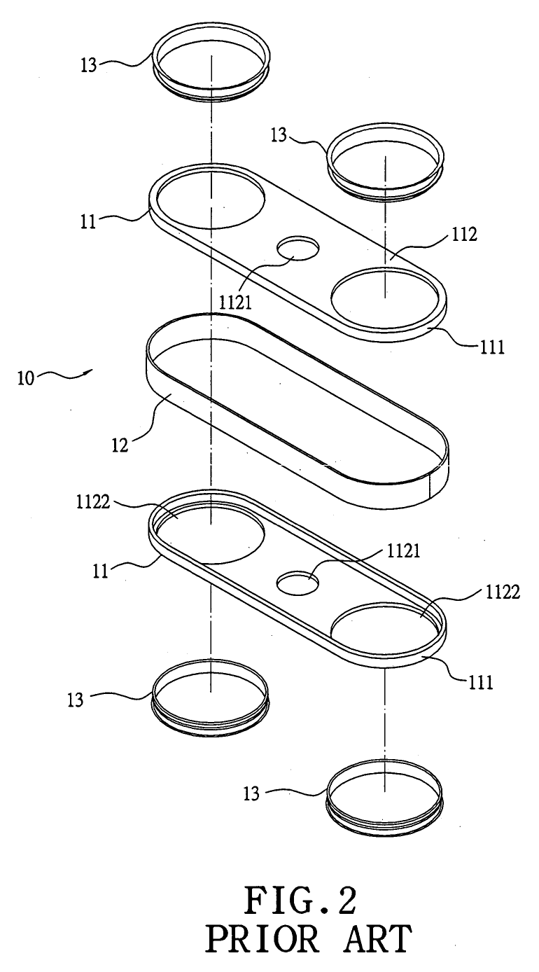

FIG. 3 is a partial cross-sectional view of the exhaust box in the conventional dust collector;

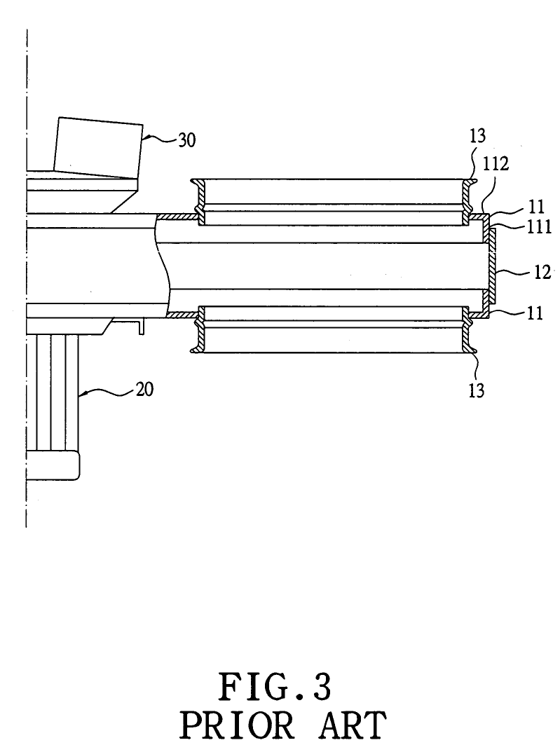

FIG. 4 is a perspective view of a dust collector in the present invention;

FIG. 5 is a perspective view of an exhaust box in the dust collector in the present invention;

FIG. 6 is an exploded perspective view of the exhaust box in the dust collector in the present invention;

FIG. 7 is a partial side cross-sectional view of the dust collector in the present invention;

FIG. 8 is an upper view of the dust collector in the present invention; and,

FIG. 9 is a side cross-sectional view of an intermediate hoop attached an airtight gasket in the present invention.

### DETAILED DESCRIPTION OF THE PREFERRED EMBODIMENT

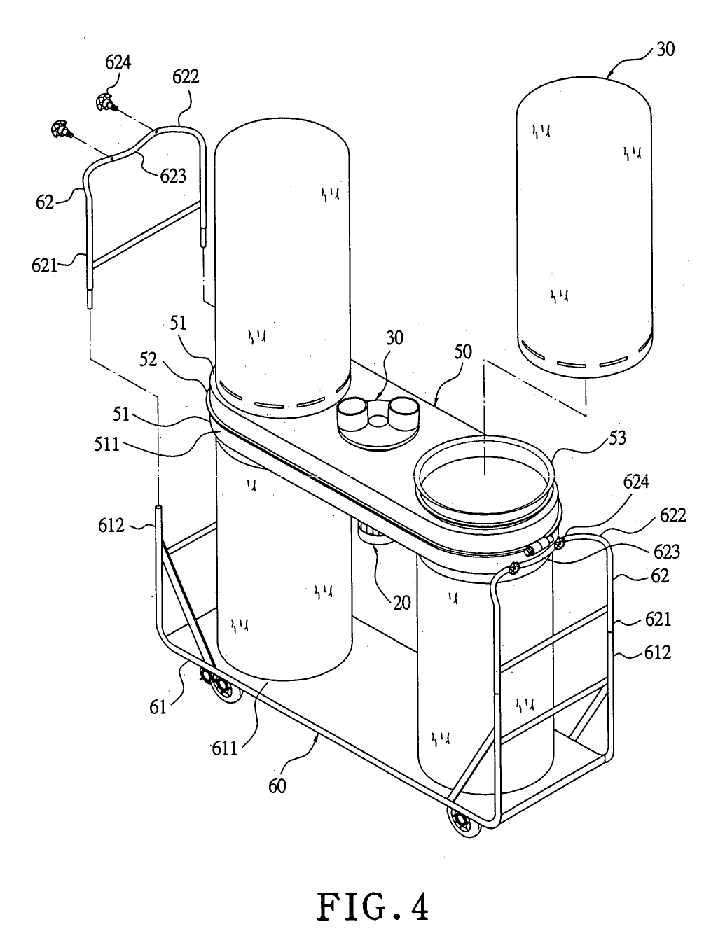

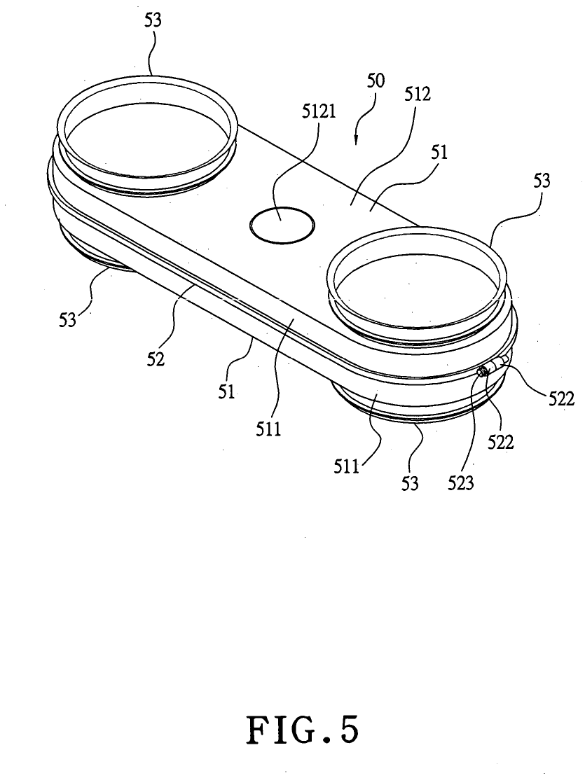

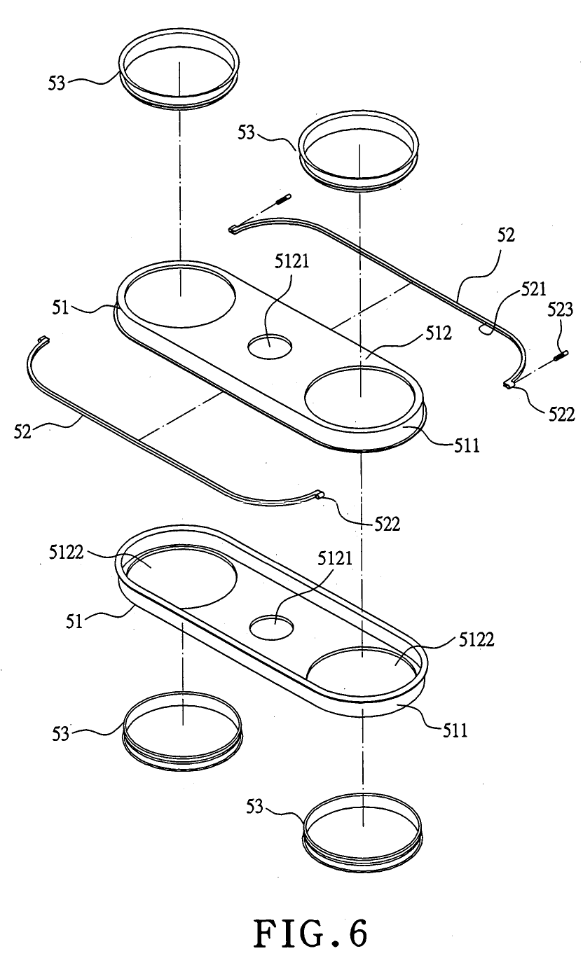

A preferred embodiment of a dust collector in the present invention, as shown in FIGS. 4, 5 and 6, having almost the same structure as the conventional one, includes an exhaust box 50, a supporter 60, and a plurality of dust bags 30 and main components.

The exhaust box 50 consists of two housings 51, two intermediate half hoops 52, and two sucking pipe bases 53.

The two housings 51 are combined together overlapped with each other, respectively having a circumferential wall 511 and a flat table 512 surrounded by the circumferential wall 511. The flat table 512 has a hole 5121 in the center for a fan motor 20 and the sucking pipe base 30, and two large holes 5122 for the two annular bases 53 bored in two sides. Further, each circumferential wall 511 has a flange 513 to face each other.

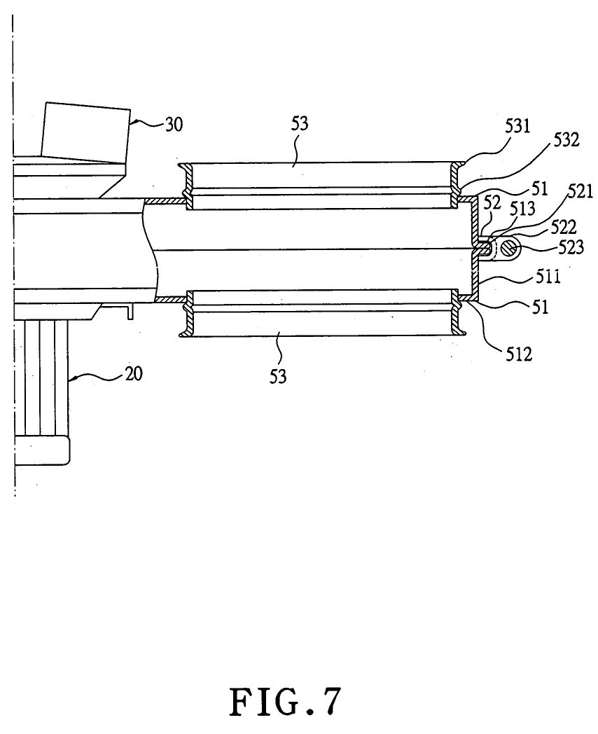

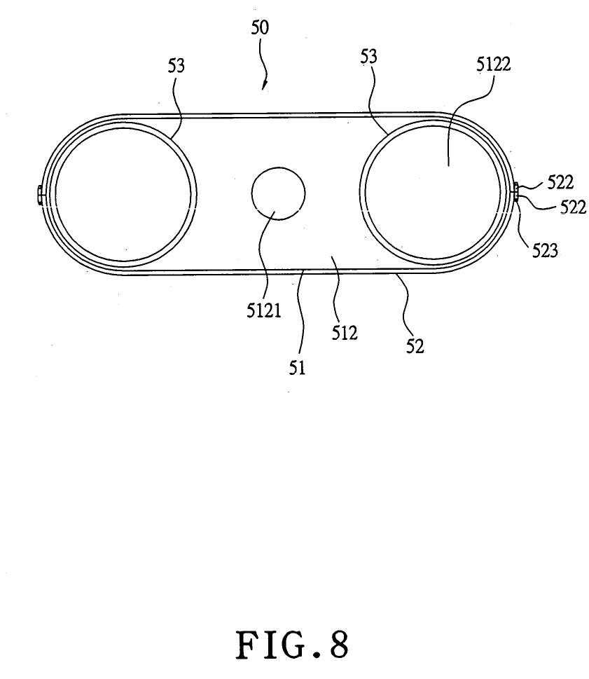

The two intermediate half hoops 52 are respectively a little smaller than the half of the flange 513, having an inner groove 521 to fit with the flanges 513 of the two housings 51 combined together. Further as shown in FIGS. 7 and 8, each intermediate half hoop 52 has a stud 522 at two ends 522 for bolts 523 to screw with for connecting firmly the two intermediate half hoops 52 together around the flanges 513 of the two housings 51, which are then kept very air-tight and stably.

The two annular bases 53 are respectively shaped as a ring, having a flange 531 at an outer end and an annular connect projection 532 at an inner end. The connect projection 532 fits around each large hole 5122 of each housing 51 and then welded together firmly. The flange 53 1 is for securing the dust bag 30 around there.

It is also possible to weld the large holes 5122 with the flanges 53 in assembling the exhaust box 50, reinforcing the tightness and the strength of the housings 51

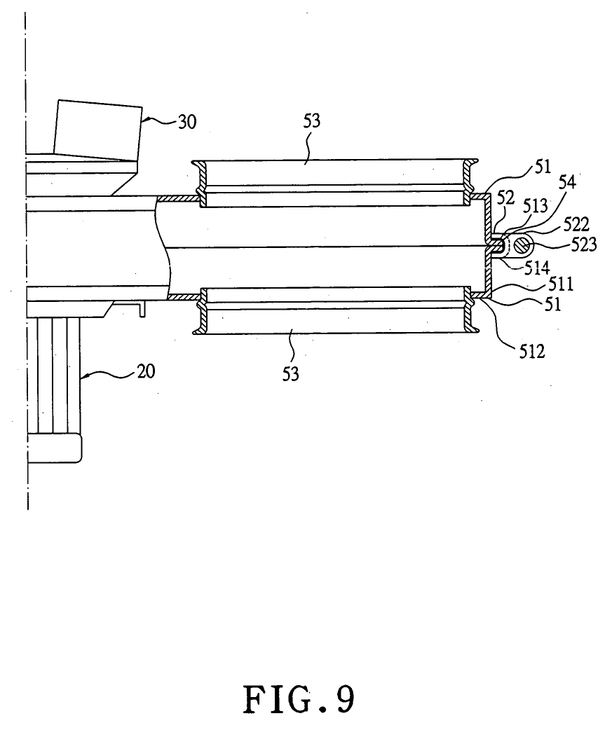

Next, as shown in FIG. 9, the intermediate groove 52 1 of the two half hoops 52 can be fitted therein with a soft air-tight gasket 54 to press against the contact line of the half hoops 52 and the two flanges 513 after the half hoops 52 are fixed around the two flanges 513 of the housings 51.

In addition, the fan motor 50 can be positioned on one side of the housings 51, with the two annular bases 51 situated at the same side, instead of the fan motor 20 situated on the center portion and the annular bases 53 positioned at two sides. Further, the fan motor 20 also can be fixed on the upper housings 51 instead of being fixed under the lower housing 51, with the sucking pipe base 30 provided under the housings 51. Then this invention may have many modes of structures available.

Furthermore, as shown in FIG. 4, the exhaust box 50 is positioned on the support frame 60, which has a lower frame 61 and two side upper frames 62. The lower frame 61 is provided with a flat table 611, four castors 6111 under the four corners of the flat table 611, and a vertical tube 612 respectively extending upright at two sides. The upper frame 62 is shaped an inverted U, having a vertical rod 621 extending downward at two sides and fitting in the upper end of each vertical tube 612 of the lower frame 61, and a upper horizontal portion 622 having a curved section 623 in the intermediate portion to fit with and prop up the lower side of the circumferential wall 511 of the lower housing 51 of the exhaust box 50. Then bolts 624 screw through the upper horizontal portion 622 and then engages with the circumferential wall 511, locking the exhaust box 50 together with the fan motor 20 with the upper frames 62 of the support frame 60. In assembling, connect the circumferential walls 511 of the housings 51 with the upper frames 62, and insert the vertical rods 621 of the upper frames 62 in the vertical rods 612 of the lower frames 61, finishing assembly. In case of collapsing the dust collector, it can be done by repeating reversely the assembling processes described just above, and then the dust collector in the invention is convenient to reduce its size for carrying or transportation.

The dust collector according to the invention has the following advantages.

1. The exhaust box consists of the two housings 51 firmly combined together by means of the two half hoops 52, without necessity of welding as the conventional dust collector does, so the whole assembly of the dust collector is easy and quick, upgrading the assembling efficiency a lot, reducing the material needed, with no problems of unqualified products, and with an extremely good aesthetic appearance.

2. The exhaust box 50 consists of the two housings 51 combined together with the two half hoops 52 without welding scabs as the conventional dust collector has, with the whole appearance of the dust collector being smooth and aesthetic.

3. The support frame 60 and the exhaust box 50 are collapsible, permitting the dust collector easily and quickly assembled and collapsed, and further, the support frame 60 consists of the two upper frames and the lower frame. Then the whole structure is stable after assembled together, and the size after collapsed become very small, convenient for carrying, transporting and storing away.

While the preferred embodiment of the invention has been described above, it will be recognized and understood that various modifications may be made therein and the appended claims are intended to cover all such modifications that may fall within the spirit and scope of the invention.

1. A dust collector comprising an exhaust collector, said dust exhaust box comprising:
Two housings, one of said housings combined with the other of said housings in an overlapped condition, each said housing having a flat portion and a circumferential wall surrounding said flat portion, said flat portion having a small hole for fixing a fan motor and a sucking pipe base therein, at least a large hole for fixing an annular base therein, each said circumferential wall having a flange to match with each other:
Two intermediate half hoops having a length a little less than the half of said flange of said housings and an inner groove to fit with the flanges of said two housings, said two half hoops firmly combined together to keep firmly said two housings combined together.

2. The dust collector as claimed in claim 1, wherein said two intermediate half hoops respectively have a stud at two ends, and are combined together firmly by means of said two studs screwed together by bolts .

3. The dust collector as claimed in claim 1, wherein a soft airtight gasket is fitted in said inner groove of each said half hoop so as to increase tightness of said flanges of said two housings.

4. The dust collector as claimed in claim 1, wherein said exhaust box has its two ends respectively fixed on a support frame, and said support frame consists of a lower frame and two upper frames, each said upper frame collapsibly combined with two sides of said lower frame and having an upper horizontal portion respectively firmly screwed with two side edges of said exhaust box.

5. The dust collector as claimed in claim 4, wherein said lower frame further has a flat table, and four castors provided under said flat table at four corners, each said upper frame having a vertical rod extending upward at two sides, said vertical rod respectively fitting in said vertical rods of said lower fame, said upper horizontal portion of each said upper frame continuing with an upper end of each said vertical rod and having an intermediate curved section fitting closely with the side wall curved edge and screwed firmly with the side wall curved edge together by two bolts.
